(19) United States
(12) Patent Application Publication
(10) Pub. No.: US 2025/0004805 A1
(43) Pub. Date: Jan. 2, 2025

(54) DYNAMIC ALLOCATION TO DISAGGREGATED SDN APPLIANCES/SWITCHES

(71) Applicant: MICROSOFT TECHNOLOGY LICENSING, LLC, Redmond, WA (US)

(72) Inventors: Gerald Roy DE GRACE, Atlanta, GA (US); Srikanth KANDULA, Redmond, WA (US); Avijit GUPTA, Redmond, WA (US); Rishabh TEWARI, Sammamish, WA (US); Arun JEEDIGUNTA VENKATA SATYA, Seattle, WA (US); Zexuan ZHAO, Bellevue, WA (US)

(21) Appl. No.: 18/216,255

(22) Filed: Jun. 29, 2023

(51) Int. Cl. G06F 9/455

(52) U.S. Cl. CPC G06F 9/45558; G06F 2009/45595

(57) ABSTRACT

Techniques are disclosed for managing connections or bidirectional flows of a communication session in a software defined network (SDN). A virtual machine determines that the communication session meets a criterion for offloading policy enforcement of the communication session to an acceleration device. The virtual machine sends to the connection processing engine, a request to offload policy enforcement of the communication session from the virtual machine to the acceleration device.

### BACKGROUND

A data center houses computer systems and various networking, storage, and other related components. Data centers are, for example, used by service providers to provide computing services to businesses and individuals as a remote computing service or provide “software as a service” (e.g., cloud computing). Software defined networking (SDN) enables centralized configuration and management of physical and virtual network devices as well as dynamic and scalable implementation of network policies. The efficient processing of data traffic is important for maintaining scalability and efficient operation in such networks.

It is with respect to these considerations and others that the disclosure made herein is presented.

### SUMMARY

Disclosed herein are systems and methods for optimizing the allocation of connections to smart switches, SDN appliances, or other network devices that provide policy enforcement, packet transformations, and packet forwarding for connections in an SDN network. Connections in an SDN network can be offloaded and processed in a data processing unit (DPU) or DPU complex that comprises one or more smart switches, SDN appliances, or other network devices. In an example, a connection and connection state can be for a TCP connection. In some embodiments, a virtual machine or other user can request the need for policy enforcement for connections to be offloaded to the DPU or DPU complex. Alternatively, the SDN network can dynamically detect the need for the offload using thresholds or other mechanisms.

The present disclosure provides techniques to allow for efficiency improvements in establishing and maintaining connection states across devices in an SDN. The present disclosure enables an architecture that uses less accelerator hardware as virtual machines (VMs) do not need acceleration, as described herein, at all times. The described techniques can allow for virtual computing environments to support a variety of configurations while maintaining efficient use of computing resources such as processor cycles, memory, network bandwidth, and power. This Summary is provided to introduce a selection of concepts in a simplified form that are further described below in the Detailed Description. This Summary is not intended to limit the scope of the claimed subject matter. Furthermore, the claimed subject matter is not limited to implementations that solve any or all disadvantages noted in any part of this disclosure.

### DRAWINGS

The Detailed Description is described with reference to the accompanying figures. In the description detailed herein, references are made to the accompanying drawings that form a part hereof, and that show, by way of illustration, specific embodiments or examples. The drawings herein are not drawn to scale. Like numerals represent like elements throughout the several figures.

FIG. 1A is a diagram illustrating an example architecture in accordance with the present disclosure.

FIG. 1B is a diagram illustrating an example architecture in accordance with the present disclosure.

FIG. 1C is a diagram illustrating an example architecture in accordance with the present disclosure.

FIG. 2 is a diagram illustrating an example connection record in accordance with the present disclosure;

FIG. 3 is a flowchart depicting an example procedure in accordance with the present disclosure:

FIG. 4 is an example computing system in accordance with the present disclosure:

FIG. 5 is a diagram illustrating a data center in accordance with the present disclosure:

FIG. 6 is a diagram illustrating an example system in accordance with the present disclosure.

### DETAILED DESCRIPTION

The disclosed embodiments enable datacenters to provide services in a manner that can reduce the cost and complexity of their networks, allowing for more efficient use of computing, storage, and network resources. Efficient implementation of the end-to-end service by a cloud service provider can enable an experience that is seamless and more consistent across various footprints. The integration of multi-tenant and single-tenant resources with a comprehensive resource management approach can also minimize the overhead for the user, who will not need to address policy enforcement issues and perform other complex management tasks. The efficient implementation of the described synchronization functions can provide improvements for various performance and security metrics such as latency and data security.

The present disclosure describes embodiments for optimizing data processing units (DPUs) in smart switches, SDN appliances, or other devices to efficiently manage connections and utilization of associated services. A DPU, in one example, is a component that is configured for packet processing and can be implemented as hardware, software, or a combination. In one embodiment, the DPU is implemented as an ASIC. As discussed further herein, DPU processing can include fast path and slow path processing within a programmable data path. The slow path evaluates every connection against a set of rules that can be complex in nature. The rules dictate whether a packet is allowed to continue its destination either directly or through an intermediate device. For example, the rules can cover allow/deny/mirror, actions as well as the transformation that the packet must undergo including any modification to the packet or tunnel layers. The rules can be applied in both directions for any packet that leaves or attempts to enter a virtual machine (VM) or container. Cloud environments typically support this type of functionality to ensure that virtual machines remain within their virtual network and are not allowed to access any other virtual networks or networking functions.

The processing associated with such rule application can be complex and consist of many thousands of rules and related tables. After the processing is complete for the first packet of a connection (this processing is referred to as the “slow path”), the connection can subsequently be matched according to the connection's 5 tuple without performing the full rule processing. For this reason, the connection can be placed into a “fast path” where the exact matched connection and transformation can be consulted using much simpler table lookup algorithms. This results in much higher ongoing performance for established connections. Although fast path processing is much simpler than slow path processing, the capacity to continuously add more connections can be limited. For example, the table to hold the established connections can sometimes reach their capacity and can limit the number of connections that a VM can source or sink.

The allocation of SDN appliances can be matched to the deployed servers within compute clusters comprising a cluster of servers. In some cases, some portion of VMs deployed within the cluster of servers may exceed the capabilities of a given server to keep up with connection processing, connection table expansion, or other tasks. This portion of VMs can vary based on the deployment workloads. It is desirable to selectively offload connections to the fast path to respond to actual local and network conditions.

The disaggregation techniques described herein allow for the upfront identification of VMs to process SDN data path rules and transformations by a disaggregated SDN appliance. In some embodiments, a VM or other user can select a flag or other mechanism to move the SDN data path rule and transformation processing for the VM to a disaggregated SDN appliance. By pushing connections for a given VM to the SDN appliance in this manner and without automatically offloading all of the connections on a server, the server continues to process most SDN workloads while only a portion of the VMs are re-directed to the SDN appliance. This can be more cost effective than increasing the capabilities on every server whereas only a small fraction of VMs may require high processing rates or niche services that require the speed enhancements allowed by SDN appliance fast path offloading.

In some cases, if the offloading of connections is entirely driven by the VM or user, disaggregated SDN appliance occupancy may be inefficient. For example, a user may tag the VM as needing extra processing of SDN data path and transformations while using far less than the capabilities of the SDN appliance. Additionally, even if a VM occasionally requires additional processing, such processing may only be needed for short periods of time, leaving the capabilities of the SDN appliance under-utilized most of the time.

To address the above issues, the present disclosure provides a way to optimize the use of the SDN appliance or DPU complex infrastructure. In an embodiment, a user or VM can flag the need for this capability. In some embodiments, the system can detect the need for the SDN offload dynamically using thresholds or other mechanisms. As used herein, a DPU complex or SDN appliance can include one or more devices that are configured to process packets in the manner described herein, which can include an appliance or switch and optionally a server or other computing device.

In various embodiments, if a VM performance threshold is reached on the host, the host can request the SDN controller to apply SDN rules to the appliance and make the appliance the preferred route on the way to the VM. This process can include the SDN appliance parsing and identifying the rules and policies that are applicable to the VM and initiating a process to synchronize the associated connections from the VM (or the server hosting the VM) to the SDN appliance. In one embodiment, packets can be directed to the SDN appliance for application of the rules and policies. For example, the appliance routing can be achieved by updating the next hop IP address of the tunnel set up for the communication to the destination. Once the tunnel rule is updated, any new connections will start to flow through the SDN appliance. Before updating the tunnel rules, the connection manager or other function can perform a synchronization process to ensure that the SDN appliance is capable of handling both established and any new connections. Assuming the SDN appliance is preferred over the server, the number of new connections can be reduced for a short period of time so that the overhead of dynamically synchronizing new connections is low.

In one embodiment, an example sequence is as follows:

A performance or table threshold is reached on a VM.

A request is sent to move an SDN data path to a SDN appliance.

Policies of the VM are updated to one or more SDN appliances. An SDN policy enforcement/forwarding engine manages connections generally.

The SDN policy enforcement/forwarding engine performs a synchronization to the SDN appliance.

Once synchronization is complete, the tunnel route on the VM host is updated to send all new connections to the SDN appliance.

Connections for a short period of time will arrive at the server where the VM is hosted, but no longer than the time required to re-route the connection paths through the SDN appliance.

These connections will be processed at the server through its policy enforcement engine. However, the connection state will also be forwarded to the SDN appliance.

The SDN appliance will process any new connections as they arrive.

After a period of time, all connections for the VM will flow through the SDN appliance.

All connections for the VM will no longer flow directly to the server where the VM is hosted.

The server's SDN policy enforcement/forwarding engine will at this time be able to remove any connection that is not flowing through the tunnel between itself and the SDN appliance, freeing up resources on the server.

After this sequence is complete, all SDN policy processing and forwarding will be performed by the SDN appliance with higher connection performance.

The described process can move connections between the server and the SDN appliance in the reverse direction. This can take place, for example, in response to determining that the threshold is no longer being met or otherwise that the performance provided by SDN appliance offloading is no longer needed. Returning a connection to the server host allows the SDN appliance to be optimally utilized and leads to less overall deployment while optimally maintaining the level of performance provided to the server fleet in general.

The SDN appliances can be more optimally utilized as connection processing can be dynamically moved between the server and the SDN appliance based on various thresholds such as connections per second (CPS), table size, number of idle connections, etc. This avoids the use of the SDN appliance for anticipated needs that do not materialize, or for VMs that only need the performance of the SDN appliance on an infrequent basis.

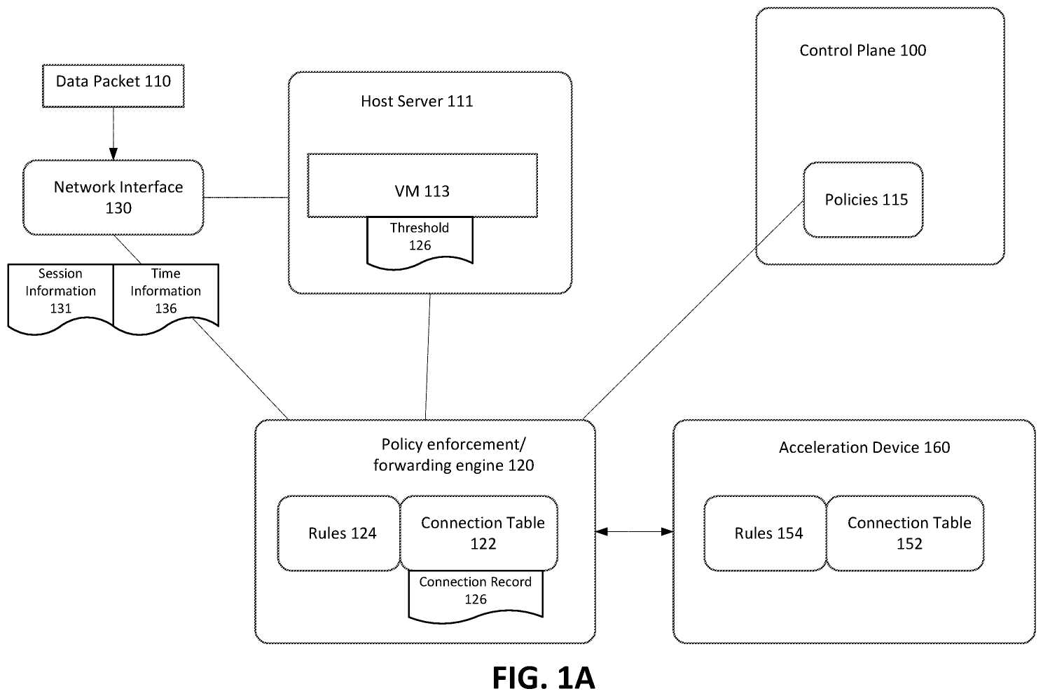

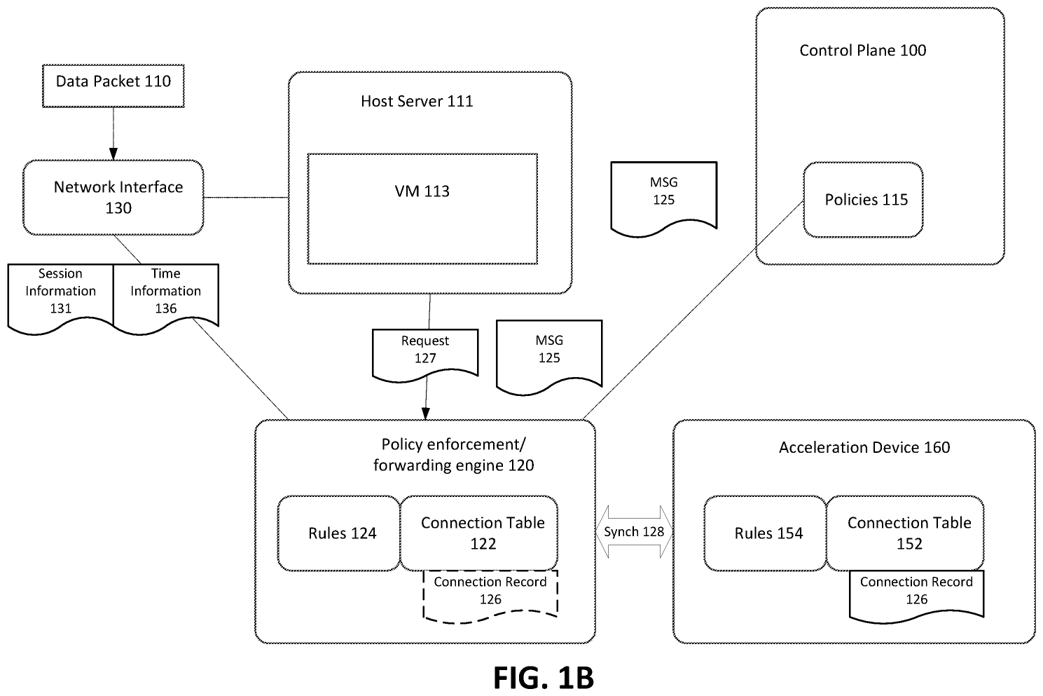

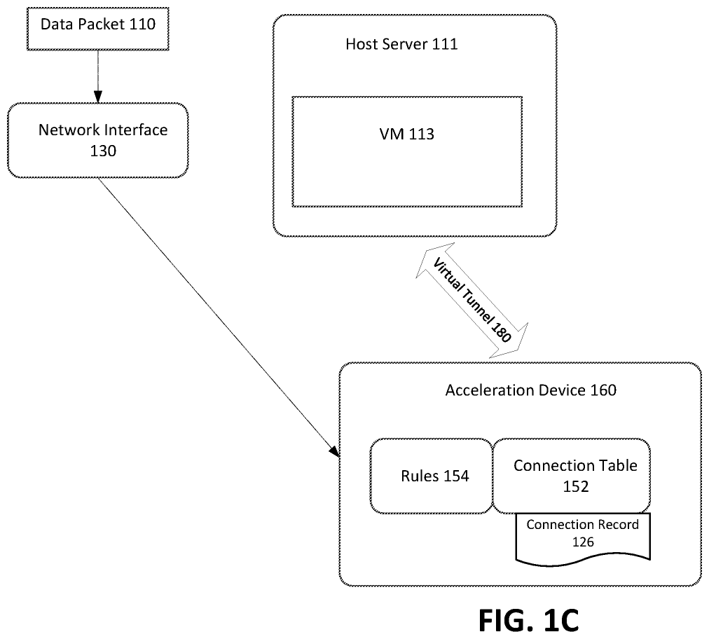

As used herein, a device that is configured to track connections in a software defined network (SDN) may include network devices, appliances, and other devices that are implemented for processing packets in SDNs and other architectures that require processing of packets that are associated with various sessions and connections. Such devices may also be referred to as an accelerator device. For example, with reference to FIG. 1A, illustrated is an example architecture illustrating packet processing according to the disclosed embodiments. In one example, a packet 110 in a data flow may be received via a network interface 130. Packet 110 may be identified and sent to a policy enforcement/forwarding engine 120 that is configured to manage processing of data flows. In some embodiments, the policy enforcement/forwarding engine 120 runs on host server 111. Acceleration device 160 can be a smart NIC, SDN appliance, smart switch, and the like. Slow path connections may be performed by policy enforcement/forwarding engine 120 and inserted into a connection table 122. The policy enforcement/forwarding engine 120 may apply applicable SDN policies 115 for the data flow associated with the data packet 110 and terminate application of the policies when the data flow is complete. Policy enforcement 124 may be applied for SDN policies 115 that are received, for example, from the SDN control plane 100.

In an example, FIGS. 1A, 1B, and 1C illustrate an example of managing connections or bidirectional flows of a communication session in a software defined network (SDN) comprising a host server 111 hosting a virtual machine 113. The SDN further comprises a policy enforcement/forwarding engine 120. The virtual machine 110 processes a packet 110 associated with the communication session. Session information 131 for the communication session is stored in a connection record 132. The virtual machine 110 determines that the communication session meets a threshold 126 for offloading rules enforcement 124 of the communication session to acceleration device 160. In response to the determination, FIG. 1B illustrates that the virtual machine 113 sends to the policy enforcement/forwarding engine 120, a request 127 to offload rules enforcement 124 from the virtual machine 110 to the acceleration device 160. A message 125 is sent to the policy enforcement/forwarding engine 120 indicating that rules applicable to the VM 113 should be enforced by the acceleration device 160. In other embodiments, the message 125 can originate from other components and can be sent to different components depending on the particular implementation. The policy enforcement/forwarding engine 120 parses the rules 124 and performs a synchronization 128 of rules that are applicable to VM 113. As a result, new connections that apply to VM 113 will be entered in connection table 152 of acceleration device 160. Additionally, existing connections that are applicable to VM 113 will be transferred to connection table 152. FIG. 1C illustrates that a virtual tunnel 180 is set up for communication to VM 113 as the destination. Once the tunnel rule is updated, any new connections will start to flow through the acceleration device 160 for application of policies prior to sending to VM 113 as the destination.

Methods for creating a “fast path connection record” when a SYN packet arrives can be similar to what is commonly referred to as “slow path” as described in Disaggregated APIs for SONIC Hosts (DASH) open-source documentation found within Github. Connection flows can be re-simulated using the techniques described in application Ser. No. 17/855,730 “RE-SIMULATION OF UPDATED SDN CONNECTION FLOWS” filed Jun. 30, 2022, the contents of which are incorporated herein by reference. State synchronization can be achieved using the techniques described in application Ser. No. 17/958,346 “EFFICIENT STATE REPLICATION IN SDN NETWORKS” filed Oct. 1, 2022, the contents of which are incorporated herein by reference.

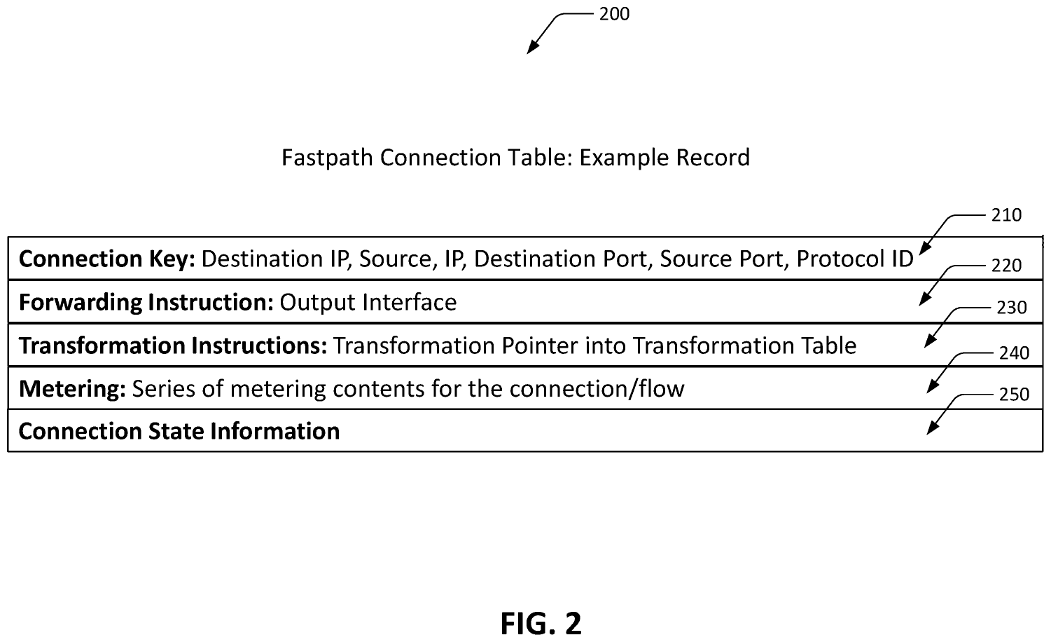

FIG. 2 illustrates an example record of a fast path connection table 200. Connection table 200 illustrates an entry for a connection key 210 that includes a Destination IP, Source IP, Destination Port, Source Port, and Protocol ID. Forwarding Instruction 220 may include, for example, an Output Interface that may indicate where the packet needs to go, such as identify an interface at a network interface card (NIC). Transformation Instructions 230 may include a Transformation Pointer into the Transformation Table. The instructions may indicate the transformations identified for packets in the flow such as applying a tunnel on it, changes of source or destination addresses, new filters, etc. Metering 240 may include a series of metering contents for the connection/flow. Metering may allow for charging based on usage, for example.

The Connection Key 210 may be a constant for the duration of the record. The Forwarding Instruction 220 output interface can be updated by the SDN control plane via re-simulation. Transformation Instructions 230 can be updated by the SDN control plane via-re-simulation. Metering 240 may be valid while the record is constant or aggregated and sent upwards if the record is changed. Connection state information 450 includes various information needed for each connection or flow.

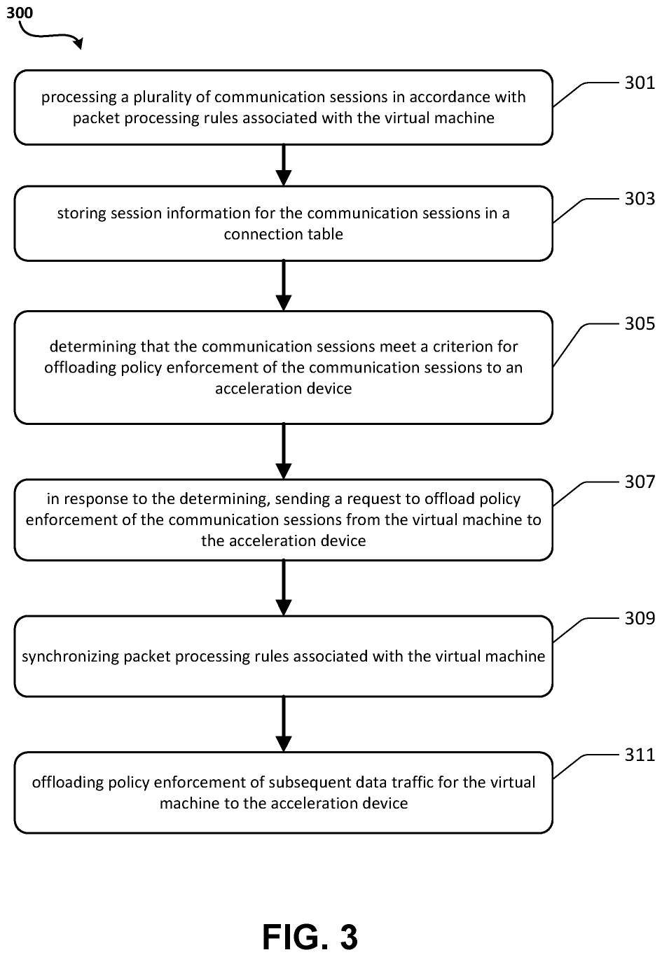

Turning now to FIG. 3, illustrated is an example operational procedure for managing connections or bidirectional flows of a communication session in a software defined network (SDN) comprising a server hosting a virtual machine. In an embodiment, the SDN comprises a policy enforcement/forwarding engine.

Such an operational procedure can be provided by one or more components illustrated in FIG. 1. The operational procedure may be implemented in a system comprising one or more computing devices. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

It should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof. Thus, although the routine 300 is described as running on a system, it can be appreciated that the routine 300 and other operations described herein can be executed on an individual computing device or several devices.

Referring to FIG. 3, operation 301 illustrates processing, by the policy enforcement/forwarding engine, a plurality of communication sessions in accordance with packet processing rules associated with the virtual machine.

Operation 303 illustrates storing, by the policy enforcement/forwarding engine, session information for the communication sessions in a connection table.

Operation 305 illustrates determining, by the virtual machine, that the communication sessions meet a criterion for offloading policy enforcement of the communication sessions to an acceleration device.

Operation 307 illustrates in response to the determining, sending, by the virtual machine to the policy enforcement/forwarding engine, a request to offload policy enforcement of the communication sessions from the virtual machine to the acceleration device.

Operation 309 illustrates synchronizing, by the policy enforcement/forwarding engine to the acceleration device, packet processing rules associated with the virtual machine. In an embodiment, the synchronizing enables traffic associated with the virtual machine to be processed by the acceleration device.

Operation 311 illustrates offloading policy enforcement of subsequent data traffic for the virtual machine to the acceleration device.

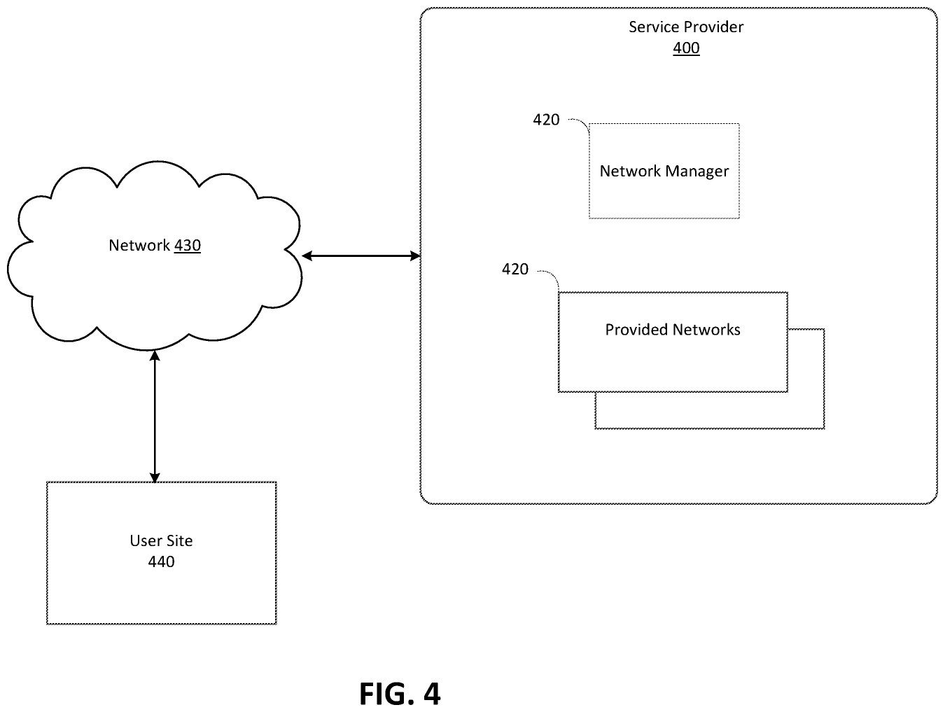

FIG. 4 illustrates an example computing environment in which the embodiments described herein may be implemented. FIG. 4 illustrates a service provider 400 that is configured to provide computing resources and provided networks 420 to users at user site 440. The user site 440 may have user computers that may access services provided by service provider 400 via a network 430. The computing resources provided by the service provider 400 may include various types of resources, such as computing resources, data storage resources, data communication resources, and the like. For example, computing resources may be available as virtual machines. The virtual machines may be configured to execute applications, including Web servers, application servers, media servers, database servers, and the like. Data storage resources may include file storage devices, block storage devices, and the like. Networking resources may include virtual networking, software load balancer, and the like.

Service provider 400 may have various computing resources including servers, routers, and other devices that may provide remotely accessible computing and network resources using, for example, virtual machines. Other resources that may be provided include data storage resources. Service provider 400 may also execute functions that manage and control allocation of network resources, such as a network manager 420.

Network 430 may, for example, be a publicly accessible network of linked networks and may be operated by various entities, such as the Internet. In other embodiments, network 430 may be a private network, such as a dedicated network that is wholly or partially inaccessible to the public. Network 430 may provide access to computers and other devices at the user site 440.

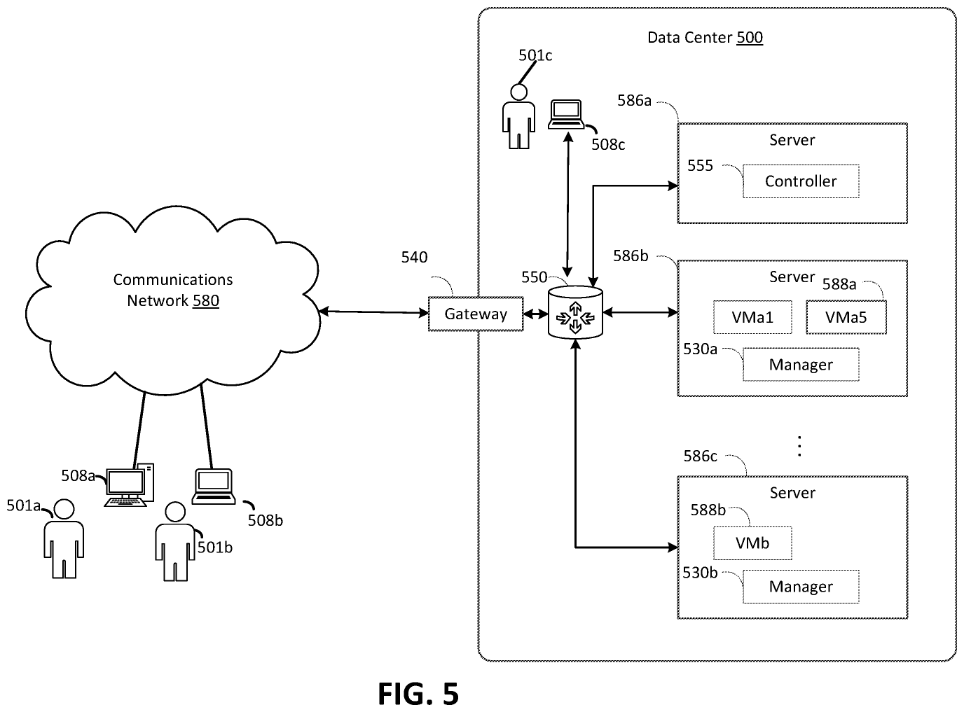

FIG. 5 illustrates an example computing environment in which the embodiments described herein may be implemented. FIG. 5 illustrates a data center 500 that is configured to provide computing resources to users 501a, 501b, or 501c (which may be referred herein singularly as “a user 501” or in the plural as “the users 501”) via user computers 508a, 508b, and 508c (which may be referred herein singularly as “a computer 508” or in the plural as “the computers 508”) via a communications network 580. The computing resources provided by the data center 500 may include various types of resources, such as computing resources, data storage resources, data communication resources, and the like. Each type of computing resource may be general-purpose or may be available in a number of specific configurations. For example, computing resources may be available as virtual machines. The virtual machines may be configured to execute applications, including Web servers, application servers, media servers, database servers, and the like. Data storage resources may include file storage devices, block storage devices, and the like. Each type or configuration of computing resource may be available in different configurations, such as the number of processors, and size of memory and/or storage capacity. The resources may in some embodiments be offered to clients in units referred to as instances, such as virtual machine instances or storage instances. A virtual computing instance may be referred to as a virtual machine and may, for example, comprise one or more servers with a specified computational capacity (which may be specified by indicating the type and number of CPUs, the main memory size and so on) and a specified software stack (e.g., a particular version of an operating system, which may in turn run on top of a hypervisor).

Data center 500 may include servers 586a, 586b, and 586c (which may be referred to herein singularly as “a server 586” or in the plural as “the servers 586”) that may be standalone or installed in server racks, and provide computing resources available as virtual machines 588a and 588b (which may be referred to herein singularly as “a virtual machine 588” or in the plural as “the virtual machines 588”). The virtual machines 588 may be configured to execute applications such as Web servers, application servers, media servers, database servers, and the like. Other resources that may be provided include data storage resources (not shown on FIG. 5) and may include file storage devices, block storage devices, and the like. Servers 586 may also execute functions that manage and control allocation of resources in the data center, such as a controller 555. Controller 555 may be a fabric controller or another type of program configured to manage the allocation of virtual machines on servers 586.

Referring to FIG. 5, communications network 580 may, for example, be a publicly accessible network of linked networks and may be operated by various entities, such as the Internet. In other embodiments, communications network 580 may be a private network, such as a corporate network that is wholly or partially inaccessible to the public.

Communications network 580 may provide access to computers 508. Computers 508 may be computers utilized by users 501. Computer 508a, 508b or 508c may be a server, a desktop or laptop personal computer, a tablet computer, a smartphone, a set-top box, or any other computing device capable of accessing data center 500. User computer 508a or 508b may connect directly to the Internet (e.g., via a cable modem). User computer 508c may be internal to the data center 500 and may connect directly to the resources in the data center 500 via internal networks. Although only three user computers 508a, 508b, and 508c are depicted, it should be appreciated that there may be multiple user computers.

Computers 508 may also be utilized to configure aspects of the computing resources provided by data center 500. For example, data center 500 may provide a Web interface through which aspects of its operation may be configured through the use of a Web browser application program executing on user computer 508. Alternatively, a stand-alone application program executing on user computer 508 may be used to access an application programming interface (API) exposed by data center 500 for performing the configuration operations.

Servers 586 may be configured to provide the computing resources described above. One or more of the servers 586 may be configured to execute a manager 530a or 530b (which may be referred herein singularly as “a manager 530” or in the plural as “the managers 530”) configured to execute the virtual machines. The managers 530 may be a virtual machine monitor (VMM), fabric controller, or another type of program configured to enable the execution of virtual machines 588 on servers 586, for example.

It should be appreciated that although the embodiments disclosed above are discussed in the context of virtual machines, other types of implementations can be utilized with the concepts and technologies disclosed herein.

In the example data center 500 shown in FIG. 5, a network device 550 may be utilized to interconnect the servers 586a and 586b. Network device 550 may comprise one or more switches, routers, or other network devices. Network device 550 may also be connected to gateway 540, which is connected to communications network 580. Network device 550 may facilitate communications within networks in data center 500, for example, by forwarding packets or other data communications as appropriate based on characteristics of such communications (e.g., header information including source and/or destination addresses, protocol identifiers, etc.) and/or the characteristics of the private network (e.g., routes based on network topology, etc.). It will be appreciated that, for the sake of simplicity, various aspects of the computing systems and other devices of this example are illustrated without showing certain conventional details. Additional computing systems and other devices may be interconnected in other embodiments and may be interconnected in different ways.

It should be appreciated that the network topology illustrated in FIG. 5 has been greatly simplified and that many more networks and networking devices may be utilized to interconnect the various computing systems disclosed herein. These network topologies and devices should be apparent to those skilled in the art.

It should also be appreciated that data center 500 described in FIG. 5 is merely illustrative and that other implementations might be utilized. Additionally, it should be appreciated that the functionality disclosed herein might be implemented in software, hardware or a combination of software and hardware. Other implementations should be apparent to those skilled in the art. It should also be appreciated that a server, gateway, or other computing device may comprise any combination of hardware or software that can interact and perform the described types of functionality, including without limitation desktop or other computers, database servers, network storage devices and other network devices, PDAs, tablets, smartphone, Internet appliances, television-based systems (e.g., using set top boxes and/or personal/digital video recorders), and various other consumer products that include appropriate communication capabilities. In addition, the functionality provided by the illustrated modules may in some embodiments be combined in fewer modules or distributed in additional modules. Similarly, in some embodiments the functionality of some of the illustrated modules may not be provided and/or other additional functionality may be available.

In some embodiments, aspects of the present disclosure may be implemented in a mobile edge computing (MEC) environment implemented in conjunction with a 4G, 5G, or other cellular network. MEC is a type of edge computing that uses cellular networks and 5G and enables a data center to extend cloud services to local deployments using a distributed architecture that provide federated options for local and remote data and control management. MEC architectures may be implemented at cellular base stations or other edge nodes and enable operators to host content closer to the edge of the network, delivering high-bandwidth, low-latency applications to end users. For example, the cloud provider's footprint may be co-located at a carrier site (e.g., carrier data center), allowing for the edge infrastructure and applications to run closer to the end user via the 5G network.

The various aspects of the disclosure are described herein with regard to certain examples and embodiments, which are intended to illustrate but not to limit the disclosure. It should be appreciated that the subject matter presented herein may be implemented as a computer process, a computer-controlled apparatus, a computing system, an article of manufacture, such as a computer-readable storage medium, or a component including hardware logic for implementing functions, such as a field-programmable gate array (FPGA) device, a massively parallel processor array (MPPA) device, a graphics processing unit (GPU), an application-specific integrated circuit (ASIC), a multiprocessor System-on-Chip (MPSoC), etc.

A component may also encompass other ways of leveraging a device to perform a function, such as, for example, a case in which at least some tasks are implemented in hard ASIC logic or the like, or a case in which at least some tasks are implemented in soft (configurable) logic or the like, a case in which at least some tasks run as software on software processor overlays or the like: a case in which at least some tasks run as software on hard ASIC processors or the like, etc., or any combination thereof. A component may represent a homogeneous collection of hardware acceleration devices. On the other hand, a component may represent a heterogeneous collection of different types of hardware acceleration devices including different types of devices having different respective processing capabilities and architectures, a mixture of devices and other types hardware acceleration devices, etc.

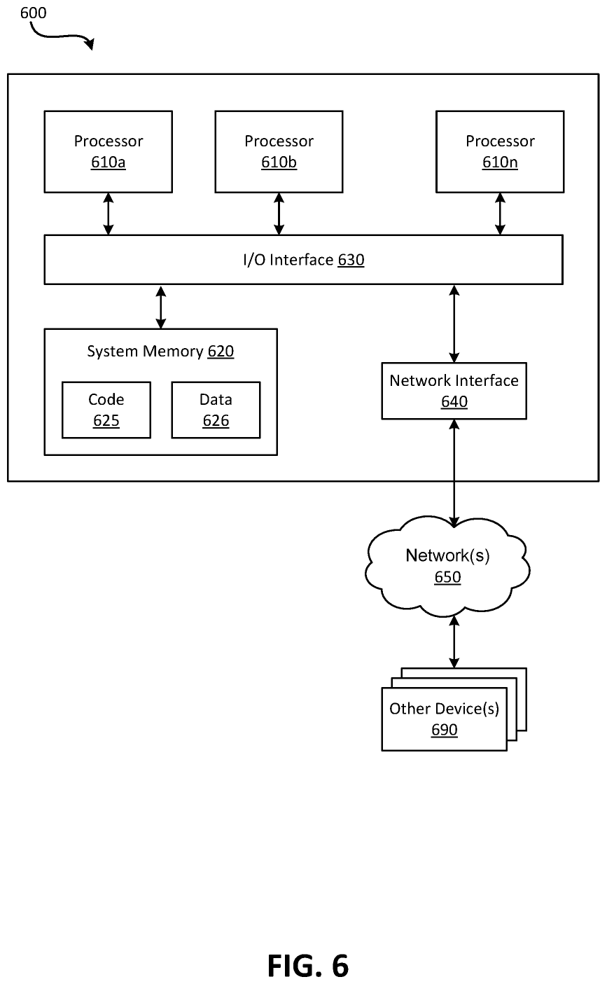

FIG. 6 illustrates a general-purpose computing device 600. In the illustrated embodiment, computing device 600 includes one or more processors 610a, 610b, and/or 610n (which may be referred herein singularly as “a processor 610” or in the plural as “the processors 610”) coupled to a system memory 620 via an input/output (I/O) interface 630. Computing device 600 further includes a network interface 640 coupled to I/O interface 630.

In various embodiments, computing device 600 may be a uniprocessor system including one processor 610 or a multiprocessor system including several processors 610 (e.g., two, four, eight, or another suitable number). Processors 610 may be any suitable processors capable of executing instructions. For example, in various embodiments, processors 610 may be general-purpose or embedded processors implementing any of a variety of instruction set architectures (ISAs), such as the x66, PowerPC, SPARC, or MIPS ISAs, or any other suitable ISA. In multiprocessor systems, each of processors 610 may commonly, but not necessarily, implement the same ISA.

System memory 66 may be configured to store instructions and data accessible by processor(s) 610. In various embodiments, system memory 66 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing one or more desired functions, such as those methods, techniques and data described above, are shown stored within system memory 620 as code 625 and data 626.

In one embodiment, I/O interface 630 may be configured to coordinate I/O traffic between the processor 610, system memory 66, and any peripheral devices in the device, including network interface 640 or other peripheral interfaces. In some embodiments, I/O interface 630 may perform any necessary protocol, timing, or other data transformations to convert data signals from one component (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components. Also, in some embodiments some or all of the functionality of I/O interface 630, such as an interface to system memory 620, may be incorporated directly into processor 610.

Network interface 640 may be configured to allow data to be exchanged between computing device 600 and other device or devices 690 attached to a network or network(s) 650, such as other computer systems or devices as illustrated in FIGS. 1 through 5, for example. In various embodiments, network interface 640 may support communication via any suitable wired or wireless general data networks, such as types of Ethernet networks, for example. Additionally, network interface 640 may support communication via telecommunications/telephony networks such as analog voice networks or digital fiber communications networks, via storage area networks such as Fibre Channel SANs or via any other suitable type of network and/or protocol.

In some embodiments, system memory 620 may be one embodiment of a computer-accessible medium configured to store program instructions and data as described above for the Figures for implementing embodiments of the corresponding methods and apparatus. However, in other embodiments, program instructions and/or data may be received, sent or stored upon different types of computer-accessible media. A computer-accessible medium may include non-transitory storage media or memory media, such as magnetic or optical media, e.g., disk or DVD/CD coupled to computing device 600 via I/O interface 630. A non-transitory computer-accessible storage medium may also include any volatile or non-volatile media, such as RAM (e.g. SDRAM, DDR SDRAM, RDRAM, SRAM, etc.), ROM, etc., that may be included in some embodiments of computing device 600 as system memory 620 or another type of memory. Further, a computer-accessible medium may include transmission media or signals such as electrical, electromagnetic or digital signals, conveyed via a communication medium such as a network and/or a wireless link, such as may be implemented via network interface 640. Portions or all of multiple computing devices, such as those illustrated in FIG. 6, may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device,” as used herein, refers to at least all these types of devices and is not limited to these types of devices.

Various storage devices and their associated computer-readable media provide non-volatile storage for the computing devices described herein. Computer-readable media as discussed herein may refer to a mass storage device, such as a solid-state drive, a hard disk or CD-ROM drive. However, it should be appreciated by those skilled in the art that computer-readable media can be any available computer storage media that can be accessed by a computing device.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computing devices discussed herein. For purposes of the claims, the phrase “computer storage medium,” “computer-readable storage medium” and variations thereof, does not include waves, signals, and/or other transitory and/or intangible communication media, per se.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the disclosed computing devices in order to store and execute the software components and/or functionality presented herein. It is also contemplated that the disclosed computing devices may not include all of the illustrated components shown in FIG. 6, may include other components that are not explicitly shown in FIG. 6, or may utilize an architecture completely different than that shown in FIG. 6.

Although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated any reference to “first,” “second,” etc. items and/or abstract concepts within the description is not intended to and should not be construed to necessarily correspond to any reference of “first,” “second,” etc. elements of the claims. In particular, within this Summary and/or the following Detailed Description, items and/or abstract concepts such as, for example, individual computing devices and/or operational states of the computing cluster may be distinguished by numerical designations without such designations corresponding to the claims or even other paragraphs of the Summary and/or Detailed Description. For example, any designation of a “first operational state” and “second operational state” of the computing cluster within a paragraph of this disclosure is used solely to distinguish two different operational states of the computing cluster within that specific paragraph—not any other paragraph and particularly not the claims.

Although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

The disclosure presented herein also encompasses the subject matter set forth in the following clauses:

Clause 1: A method for managing connections or bidirectional flows of a communication session in a software defined network (SDN) comprising a server hosting a virtual machine, the SDN further comprising a policy enforcement/forwarding engine, the method comprising:
processing, by the policy enforcement/forwarding engine, a plurality of communication sessions in accordance with packet processing rules associated with the virtual machine;
storing, by the policy enforcement/forwarding engine, session information for the communication sessions in a connection table:
determining, by the virtual machine, that the communication sessions meet a criterion for offloading policy enforcement of the communication sessions to an acceleration device;
in response to the determining, sending, by the virtual machine to the policy enforcement/forwarding engine, a request to offload policy enforcement of the communication sessions from the virtual machine to the acceleration device;
synchronizing, by the policy enforcement/forwarding engine to the acceleration device, packet processing rules associated with the virtual machine, wherein the synchronizing enables traffic associated with the virtual machine to be processed by the acceleration device; and offloading policy enforcement of subsequent data traffic for the virtual machine to the acceleration device.

Clause 2: The method of clause 1, further comprising updating a next hop IP address of a tunnel set up for the communication to the virtual machine.

Clause 3: The method of any of clauses 1-2, wherein the determining, by the virtual machine, that the communication session meets a criterion comprises meeting a performance threshold.

Clause 4: The method of any of clauses 1-3, wherein the synchronization to the acceleration device comprises parsing a plurality of packet processing rules to identify packet processing rules that are applicable to the virtual machine as a source or destination.

Clause 5: The method of any of clauses 1-4, wherein the acceleration device comprises an SDN appliance or a smart switch.

Clause 6: The method of any of clauses 1-5, further comprising returning policy enforcement of the communication session to the virtual machine.

Clause 7: The method of clauses 1-6, wherein the returning the policy enforcement is performed in response to determining that the communication session no longer meets the criterion for offloading policy enforcement of the communication session to the acceleration device.

Clause 8: A system for managing connections or bidirectional flows of a communication session in a software defined network (SDN), the system comprising:
a processing unit; and
a computer readable medium having encoded thereon computer readable instructions that when executed by the processing unit cause the system to perform operations comprising: receiving, from a virtual machine hosted by a server of the SDN, a request to offload policy enforcement of a communication session from the virtual machine to an acceleration device, wherein the communication session meets a criterion for offloading policy enforcement of the communication session to the acceleration device;
synchronizing, to the acceleration device, packet processing rules associated with the virtual machine, wherein the synchronizing enables traffic associated with the virtual machine to be processed by the acceleration device; and offloading policy enforcement of subsequent data traffic for the virtual machine to the acceleration device.

Clause 9: The hardware-based networking device of clauses 8, further comprising computer readable instructions that when executed by the processing unit cause the system to perform operations comprising updating a next hop IP address of a tunnel set up for the communication to the virtual machine.

Clause 10: The system of any of clauses 8 and 9, wherein the criterion comprises a performance threshold.

Clause 11: The system of any clauses 8-10, wherein the synchronization to the acceleration device comprises parsing a plurality of packet processing rules to identify packet processing rules that are applicable to the virtual machine as a source or destination.

Clause 12: The system of any clauses 8-11, wherein the acceleration device comprises an SDN appliance or a smart switch.

Clause 13: The system of any clauses 8-12, further comprising computer readable instructions that when executed by the processing unit cause the system to perform operations comprising returning policy enforcement of the communication session to the virtual machine.

Clause 14: The system of any clauses 8-13, wherein the returning the policy enforcement is performed in response to determining that the communication session no longer meets the criterion for offloading policy enforcement of the communication session to the acceleration device.

Clause 15: A computer readable storage medium having encoded thereon computer readable instructions that when executed by a system cause the system to perform operations comprising:
receiving, from a virtual machine hosted by a server of a software defined network (SDN), a request to offload policy enforcement of a communication session from the virtual machine to an acceleration device, wherein the communication session meets a criterion for offloading policy enforcement of the communication session to the acceleration device;
synchronizing, to the acceleration device, packet processing rules associated with the virtual machine, wherein the synchronizing enables traffic associated with the virtual machine to be processed by the acceleration device; and
offloading policy enforcement of subsequent data traffic for the virtual machine to the acceleration device.

Clause 16: The computer readable storage medium of clauses 15, wherein the criterion comprises meeting a performance threshold:
adding a connection identifier in the connection table as connections are created.

Clause 17: The computer readable storage medium of any of clauses 15 and 16, wherein the synchronization to the acceleration device comprises parsing a plurality of packet processing rules to identify packet processing rules that are applicable to the virtual machine as a source or destination.

Clause 18: The computer readable storage medium of any of the clauses 15-17, further comprising computer readable instructions that when executed by a system cause the system to perform operations comprising updating a next hop IP address of a tunnel set up for the communication to the virtual machine.

Clause 19: The computer readable storage medium of any of the clauses 15-18, further comprising computer readable instructions that when executed by a system cause the system to perform operations comprising returning policy enforcement of the communication session to the virtual machine.

Clause 20: The computer readable storage medium of any of the clauses 15-19, wherein the returning the policy enforcement is performed in response to determining that the communication session no longer meets the criterion for offloading policy enforcement of the communication session to the acceleration device.

What is claimed is:

1. A method for managing connections or bidirectional flows of a communication session in a software defined network (SDN) comprising a server hosting a virtual machine, the SDN further comprising a policy enforcement/forwarding engine, the method comprising:
processing, by the policy enforcement/forwarding engine, a plurality of communication sessions in accordance with packet processing rules associated with the virtual machine;
storing, by the policy enforcement/forwarding engine, session information for the communication sessions in a connection table;
determining, by the virtual machine, that the communication sessions meet a criterion for offloading policy enforcement of the communication sessions to an acceleration device;
in response to the determining, sending, by the virtual machine to the policy enforcement/forwarding engine, a request to offload policy enforcement of the communication sessions from the virtual machine to the acceleration device;
synchronizing, by the policy enforcement/forwarding engine to the acceleration device, packet processing rules associated with the virtual machine, wherein the synchronizing enables traffic associated with the virtual machine to be processed by the acceleration device; and
offloading policy enforcement of subsequent data traffic for the virtual machine to the acceleration device.

2. The method of claim 1, further comprising updating a next hop IP address of a tunnel set up for the communication to the virtual machine.

3. The method of claim 1, wherein the determining, by the virtual machine, that the communication session meets a criterion comprises meeting a performance threshold.

4. The method of claim 1, wherein the synchronization to the acceleration device comprises parsing a plurality of packet processing rules to identify packet processing rules that are applicable to the virtual machine as a source or destination.

5. The method of claim 1, wherein the acceleration device comprises an SDN appliance or a smart switch.

6. The method of claim 1, further comprising returning policy enforcement of the communication session to the virtual machine.

7. The method of claim 1, wherein the returning the policy enforcement is performed in response to determining that the communication session no longer meets the criterion for offloading policy enforcement of the communication session to the acceleration device.

8. A system for managing connections or bidirectional flows of a communication session in a software defined network (SDN), the system comprising:
a processing unit; and
a computer readable medium having encoded thereon computer readable instructions that when executed by the processing unit cause the system to perform operations comprising:
receiving, from a virtual machine hosted by a server of the SDN, a request to offload policy enforcement of a communication session from the virtual machine to an acceleration device, wherein the communication session meets a criterion for offloading policy enforcement of the communication session to the acceleration device;
synchronizing, to the acceleration device, packet processing rules associated with the virtual machine, wherein the synchronizing enables traffic associated with the virtual machine to be processed by the acceleration device; and
offloading policy enforcement of subsequent data traffic for the virtual machine to the acceleration device.

9. The system of claim 8, further comprising computer readable instructions that when executed by the processing unit cause the system to perform operations comprising updating a next hop IP address of a tunnel set up for the communication to the virtual machine.

10. The system of claim 8, wherein the criterion comprises a performance threshold.

11. The system of claim 8, wherein the synchronization to the acceleration device comprises parsing a plurality of packet processing rules to identify packet processing rules that are applicable to the virtual machine as a source or destination.

12. The system of claim 8, wherein the acceleration device comprises an SDN appliance or a smart switch.

13. The system of claim 8, further comprising computer readable instructions that when executed by the processing unit cause the system to perform operations comprising returning policy enforcement of the communication session to the virtual machine.

14. The system of claim 11, wherein the returning the policy enforcement is performed in response to determining that the communication session no longer meets the criterion for offloading policy enforcement of the communication session to the acceleration device.

15. A computer readable storage medium having encoded thereon computer readable instructions that when executed by a system cause the system to perform operations comprising:
receiving, from a virtual machine hosted by a server of a software defined network (SDN), a request to offload policy enforcement of a communication session from the virtual machine to an acceleration device, wherein the communication session meets a criterion for offloading policy enforcement of the communication session to the acceleration device;
synchronizing, to the acceleration device, packet processing rules associated with the virtual machine, wherein the synchronizing enables traffic associated with the virtual machine to be processed by the acceleration device; and
offloading policy enforcement of subsequent data traffic for the virtual machine to the acceleration device.

16. The computer readable storage medium of claim 15, wherein the criterion comprises meeting a performance threshold.

17. The computer readable storage medium of claim 15, wherein the synchronization to the acceleration device comprises parsing a plurality of packet processing rules to identify packet processing rules that are applicable to the virtual machine as a source or destination.

18. The computer readable storage medium of claim 15, further comprising computer readable instructions that when executed by a system cause the system to perform operations comprising updating a next hop IP address of a tunnel set up for the communication to the virtual machine.

19. The computer readable storage medium of claim 15, further comprising computer readable instructions that when executed by a system cause the system to perform operations comprising returning policy enforcement of the communication session to the virtual machine.

20. The computer readable storage medium of claim 15, wherein the returning the policy enforcement is performed in response to determining that the communication session no longer meets the criterion for offloading policy enforcement of the communication session to the acceleration device.
